(19) United States
(12) Patent Application Publication
(10) Pub. No.: US 2010/0306130 A1
(43) Pub. Date: Dec. 2, 2010

(54) Financial Protocol For Calculating True Interest Rates When Borrowing or Calculating True Returns On Investments (True Interest-True Return)

(76) Inventor: Jon Nils Fogelberg, Dresser, WI (US)

Correspondence Address: Jon Nils Fogelberg, 836 207th Street, Dresser, WI, 54009, US

(21) Appl. No.: 12/784,199

(22) Filed: May 20, 2010

Related U.S. Application Data
(60) Provisional application No. 61/181,096, filed on May 26, 2009.

(51) Int. Cl. G06Q 40/00

(52) U.S. Cl. 705/36 R

(57) ABSTRACT

Embodiments of the present invention relate to using electronic spread sheet technology in a new way to calculate true interest costs and to calculate true returns on investments. It is shown that a single financial protocol may be utilized to solve any number of interest and return problems. The new protocol is specifically effective in solving problems which entail real life irregular time intervals between financial transactions which do not conform to intervals utilized by conventional formulas or calculators. The invention calculates a unique “time-currency” basis for each borrowing or investment event and annualizes that basis to create an exact equal comparison between borrowing or investment options. The protocol results in allowing users to proceed with increased confidence when weighing financial alternatives thereby allowing users to improve the opportunity to increase their wealth.

### CROSS-REFERENCE TO RELATED APPLICATIONS

This application claims the benefit of U.S. provisional application Ser. No. 61/181,096, filed May 26, 2009.

### FEDERALLY SPONSORED RESEARCH OR DEVELOPMENT

Not Applicable

### NAMES OF THE PARTIES TO A JOINT RESEARCH AGREEMENT

Not Applicable

### SEQUENCE LISTING APPENDIX ON COMPACT DISC

Not Applicable

### BACKGROUND OF THE INVENTION

History books record the fact that loans of grain and metals were common circa 3000 B.C. and that often these loans carried interest. Today borrowing, lending, and investing are commonplace activities. These activities require methods to calculate interest rates and returns on investments to enable borrowers to know what interest rates they are paying and to enable investors to know their return on investments. The current methods to calculate interest rates or to calculate returns utilize mathematical formulas or electronic calculators or interest tables or built-in electronic spreadsheet functions. Unfortunately many of these current methods are not fully accurate because they are based on assumptions that are incomplete or can not reflect the actual terms that are quoted or do not include fee-based transaction costs.

This invention is unique in that a single financial protocol can be applied to a multitude of financial problems or opportunities and the application of this protocol will always result in true accurate solutions thereby enabling users to make more informed financial decisions.

### BRIEF SUMMARY OF THE INVENTION

Embodiments of the present invention relate to performing interest calculations and return calculations by keeping track of all the cost or return elements of an economic transaction and monitoring those costs or returns over actual real-time periods and not theoretical uniform time periods.

For example, when calculating the return on investment for a stock, the financial protocol of the present invention keeps track not only of the cost of the stock but all related costs such as transaction brokerage costs, margin interest costs and, if applicable, any early sale penalties.

### BRIEF DESCRIPTION OF THE DRAWING

FIG. 1 discloses the formulas for the invention;

FIG. 2 through FIG. 10 shows exemplary practical illustrations that the invention solves. Specifically:

FIG. 2 illustrates a simple interest calculation when the principal is $10,000 and 10% interest is paid annually;

FIG. 3 illustrates a compound calculation when the principal is $10,000 and 10% interest is compounded and paid annually;

FIG. 4 illustrates a True Interest calculation when the principal is $10,000 and payments are made randomly;

FIG. 5 illustrates and calculates the True Interest rates when the Rule of 78's is applied at various time intervals for a $5,000 loan with $1,000 interest;

FIG. 6 illustrates how to calculate the True Return to the bank when the bank charges a $39.00 fee for a returned check paid 5 days late.

FIG. 7 illustrates and calculates the True Return on prepaying a five year magazine subscription worth $130 for an advance payment of $98;

FIG. 8 illustrates and calculates the True Return when a purchasing department takes advantage of an 2% Net 10 discount payment offer;

FIG. 9 illustrates how to calculate the True Return for five stocks purchased over irregular time periods compared to a current brokerage statement;

FIG. 10 illustrates how to calculate the individual True Return for each of five stocks purchased as shown in FIG. 9.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally is a financial protocol for calculating true interest rates when borrowing or when calculating true returns on investments.

The invention uses electronic spread sheet technology to calculate true interest costs or true investment returns covering every borrowing or investment opportunity by incorporating every cost or return element into a single process thereby enabling the user to compare and select their optimum choice to maximize their financial results.

The invention calculates a unique “time-currency” basis for each borrowing or investment event and annualizes that basis to create an exact equal comparison between borrowing or investment options.

The invention permits staggered payment or investment dates and calculates all cost elements including fees and transaction costs and permits sorting and adding separate accounts into a single account to more clearly define financial results as needed.

Typical methods of financial analysis require formulas that assume equal periodic payments or abstract time values of currency that attempt to make financial comparisons equal. They can not use staggered payments or they can not integrate fees or they can not use a single calculation for different types of borrowing or investing opportunities on a comparable basis.

The invention can calculate results on a real time basis and does not rely on generally accepted current methods of interest quotations such annual percentage rate (APR) or quarterly mutual fund return comparisons. The invention takes into account leap years.

The invention uses an electronic spreadsheet format with rows and columns. The spreadsheet is divided into an inactive portion on the left where the rows describe the various financial elements to be studied (Rows A) and the columns describe the type of borrowing or investment (Columns B). The inactive portion of the spreadsheet does not enter into the calculations in determining the true interest or the true return. The active portion of the spreadsheet begins with the Event Date (Column C) where the date of each financial event is entered in separate consecutive rows in sequential date order. The next column (Column D) calculates the Elapsed Time Interval between each of the sequential events listed in Column C. The calculation uses the Date Function built into the spreadsheet by calculating the number of days between the date in the row and the date shown in the previous row. The next column (Column E) accumulates the Total Elapsed Time by adding all the days calculated for each row in a sequential manner. Columns C, D and E comprise the time portion of the invention. Any element of time may be employed, but a useful time element is one day (24 hours). The next column (Column F) is used to record the currency element for each event date as shown by each row of the time element. Any currency may be used but useful in the United States is the US dollar. The dollars amount entered is the dollar amount invested or borrowed for each date. The next column (Column G) accumulates the Total Investment or Loan by calculating and accumulating the Total Investment sums for each day in a sequential manner. Columns F and G comprise the currency invested or borrowed portion of the invention. Column H begins on the second row down.

This is the same row in which the second sequential date is entered in Column C and is calculated by multiplying the calculated elapsed time interval on the same row times the Total Investment or Loan shown on the preceding row of Column G. This represents the time-currency term or the amount of time each unit of currency has been invested or borrowed for each time interval. The next column (I) accumulates the Total time-currency by adding all the time-currency calculated for each row in a sequential manner row by row. Columns H and I comprise the time-currency invested or borrowed portion of the invention. The next column (Column J) inputs the current market value of the investment or the total earnings from a loan or investment that is calculated from market data, summarized on an account statement or projected for an investment or the amount of interest paid or earned for a loan or borrowed amount. The next column (Column K) represents the calculated dollar amounts of the true interest or true return for each row time interval. The sum of these dollar amounts represents the total earnings for an investment or the total interest on borrowings during the life span of the investment or loan and these amounts represent the accumulated earnings or interest and are stated in the next column (Column L). Column M states the percentage rate of change of the rate of return on an investment or the percentage rate of change of the interest on borrowings Column M is calculated by dividing the sequential interest or return in Column K (or the sequential differences shown in Column J) by the total time-currency amount shown in Column H for the same date. The result is then calculated and annualized by multiplying that result by 365 for comparison purposes. Column K, Column L and Column M represent the dollar and percentage rates of change of a given loan or investment; these Columns are useful in tracking the sequential dollar and percentage rate of change for certain loans or investments but are considered optional for certain types of loans or investment where the rate of change is not considered to be useful. The final column (Column N) is the cumulative true interest or true return and is calculated by dividing the difference between Column J and Column G by the total time-currency units shown in Column I (all for the same date shown on each row). The result is then annualized by multiplying that result by 365 for comparison purposes. Column N represents the true interest rate percentage or true return percentage when borrowing or when calculating returns on investment. Thus Column N represents the most useful, concrete and tangible result demonstrating that a single new method utilizing the new time-currency concept can be used to solve innumerable financial problems while maintaining both simplicity and comparability.

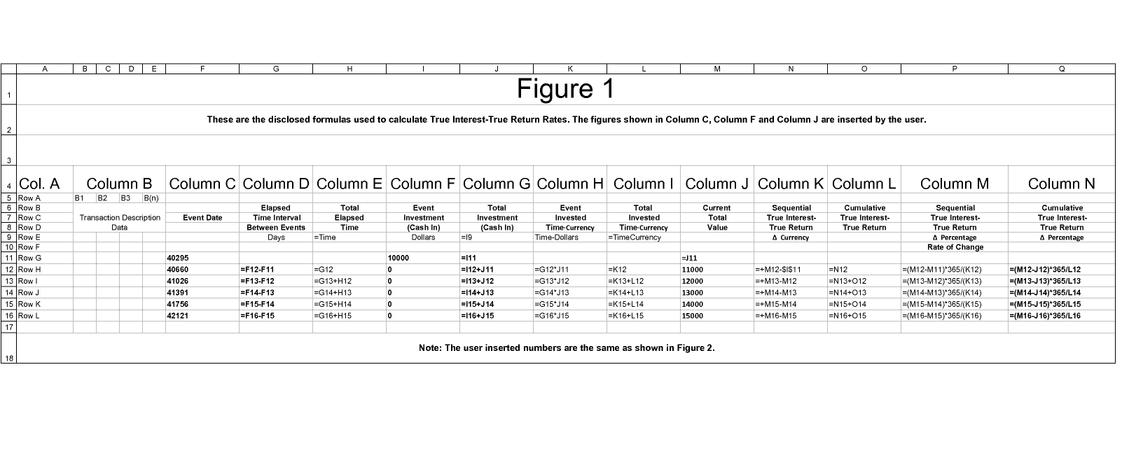

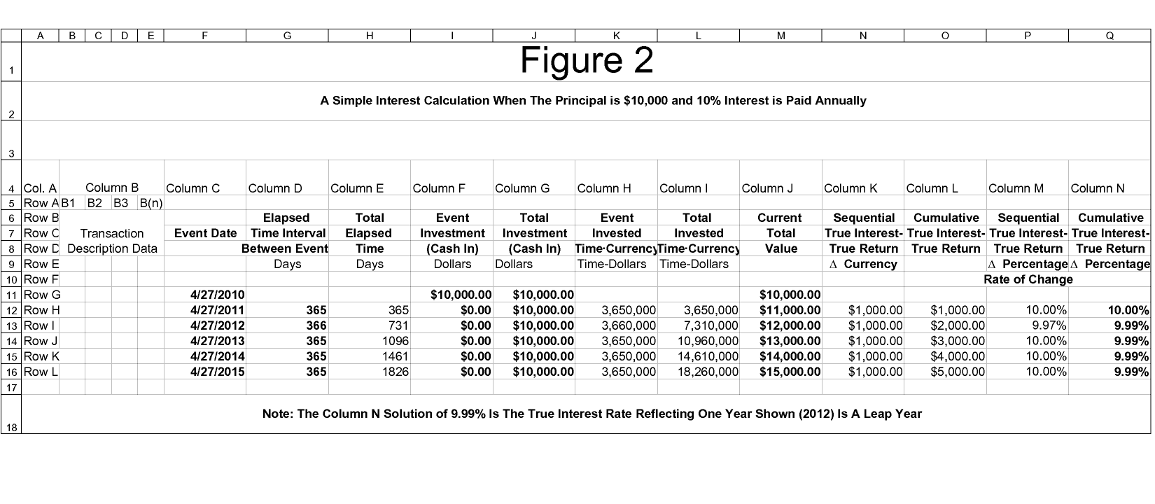

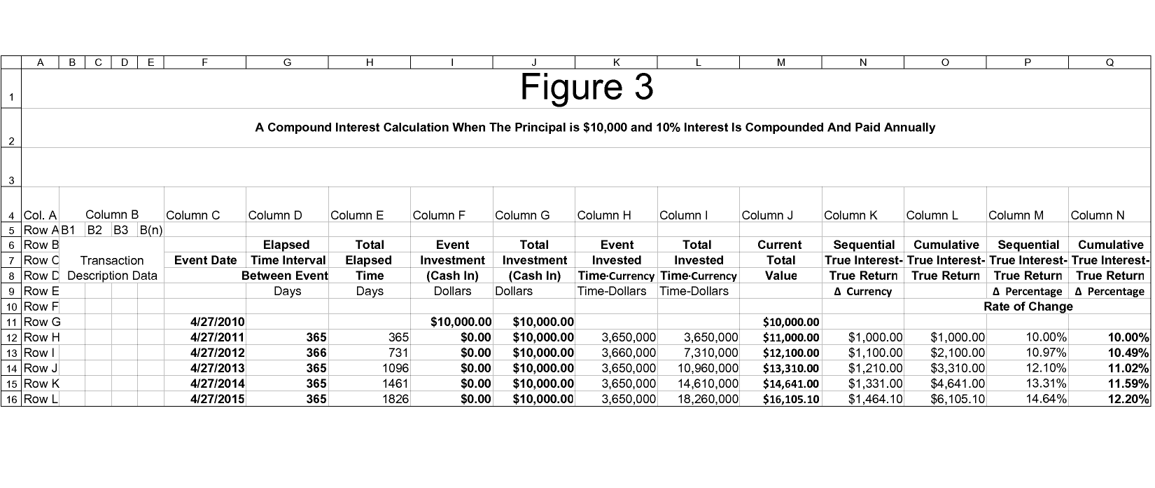

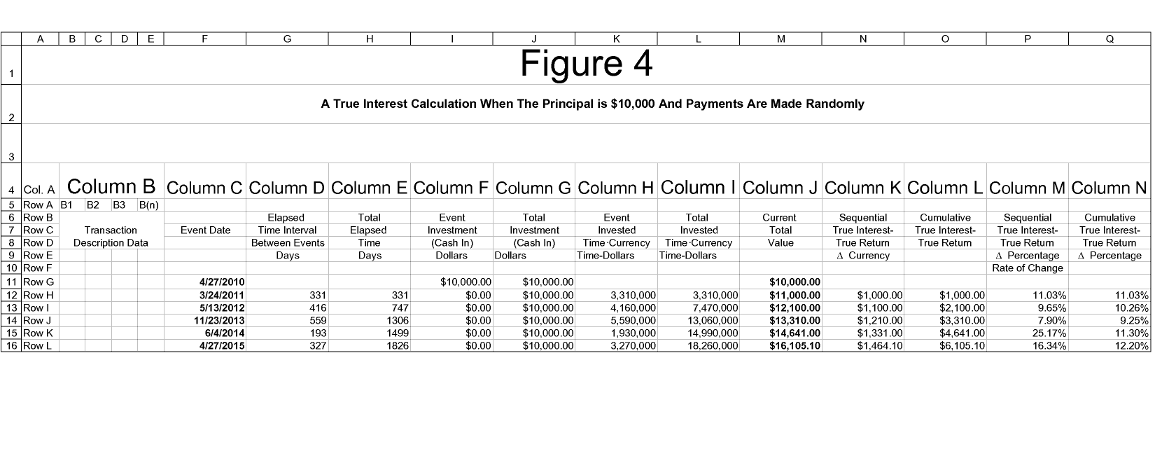

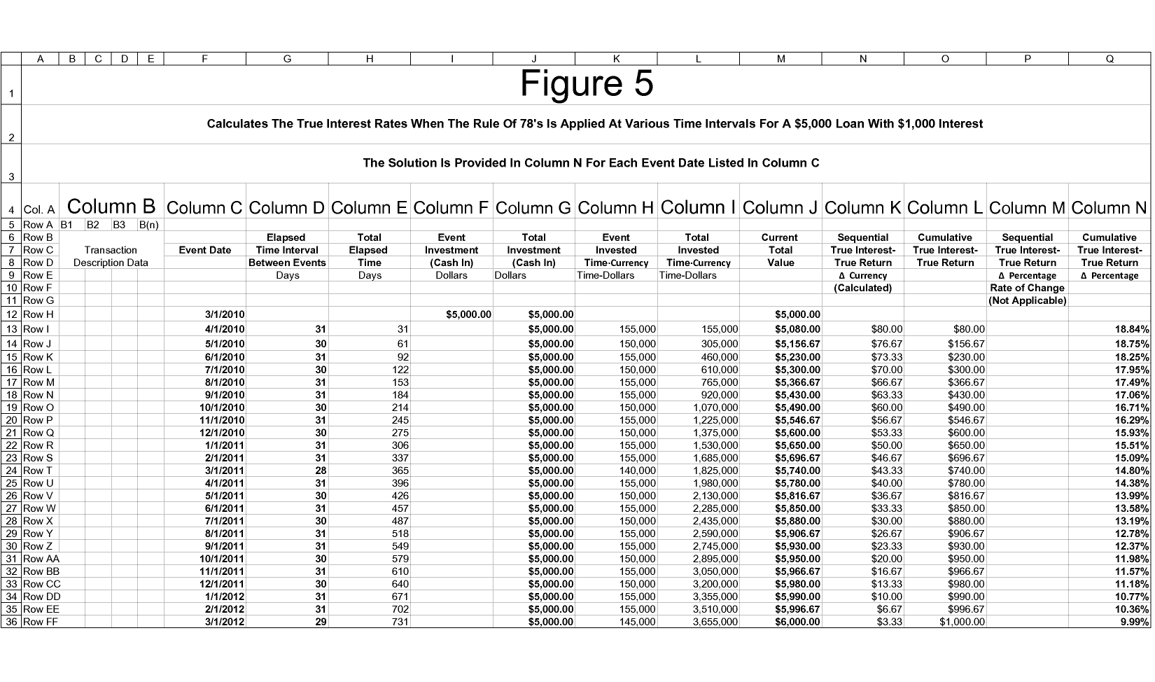

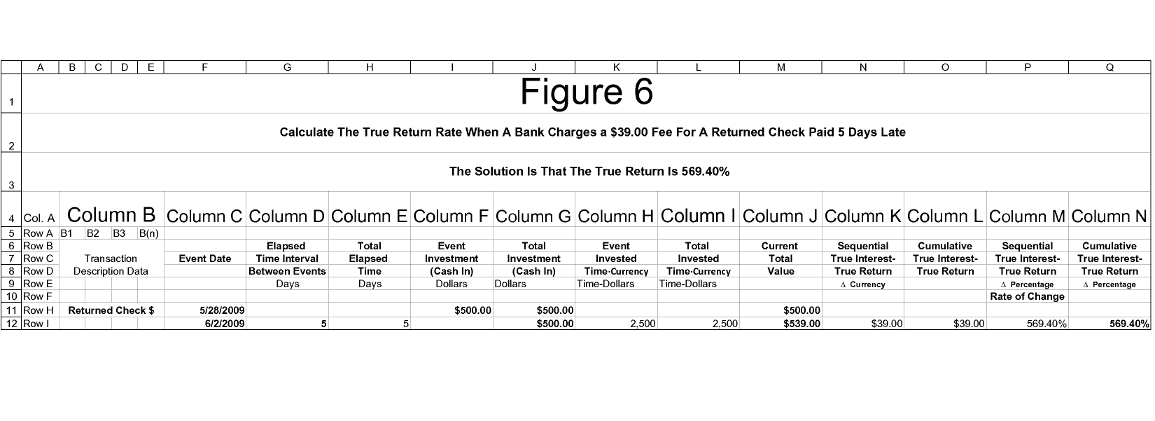

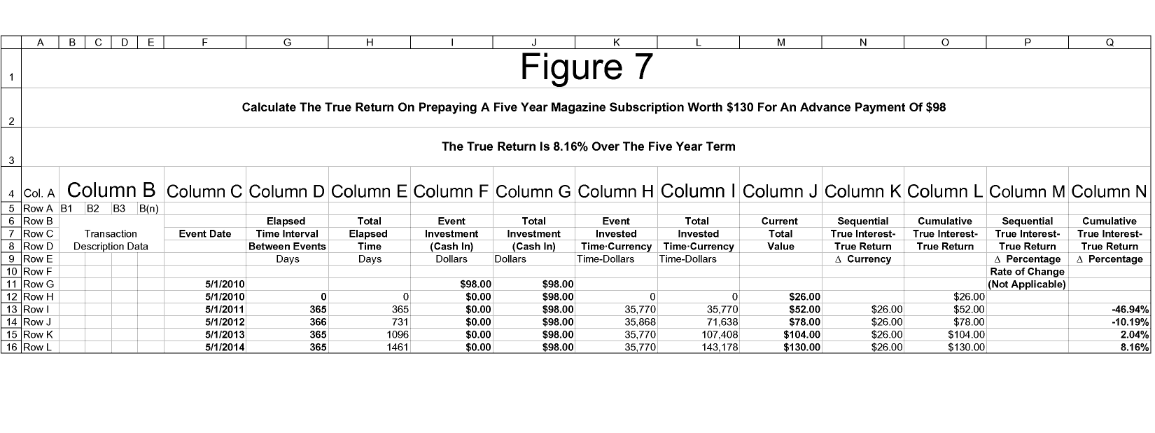

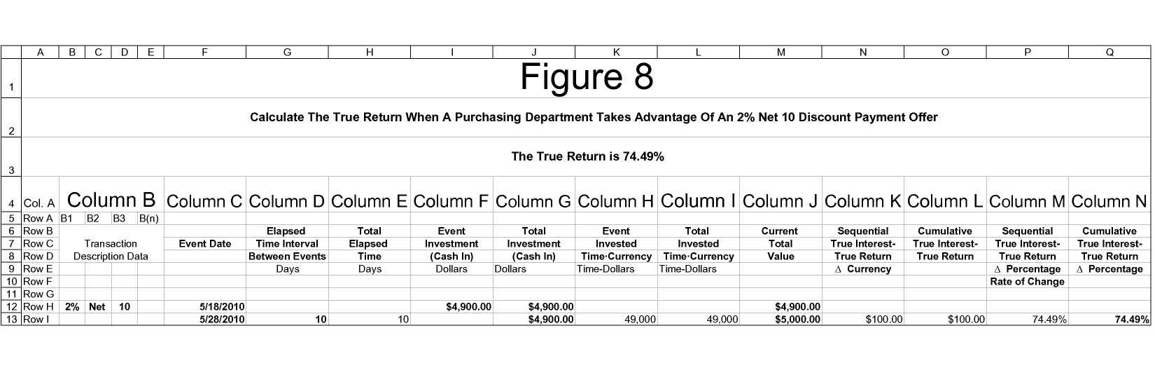

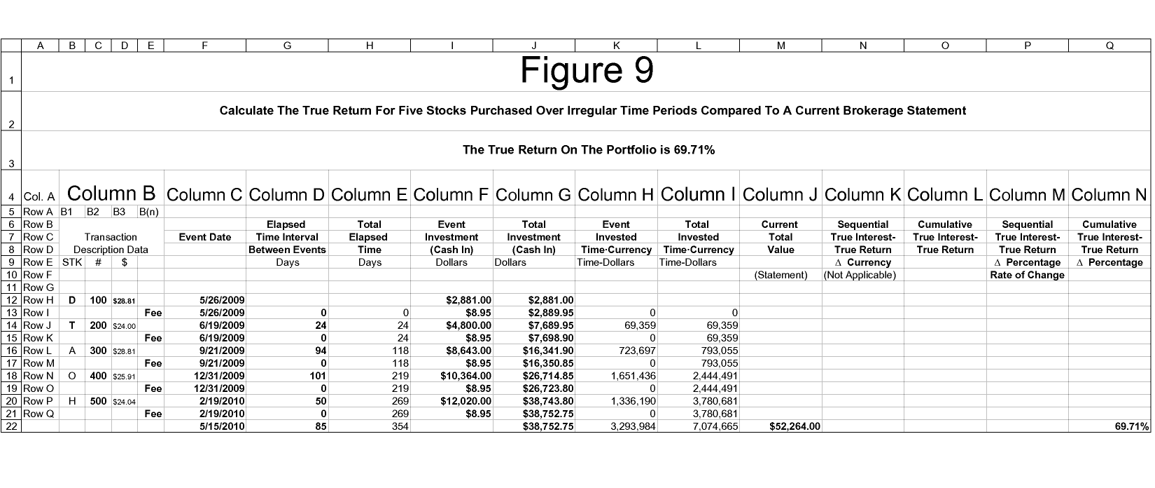

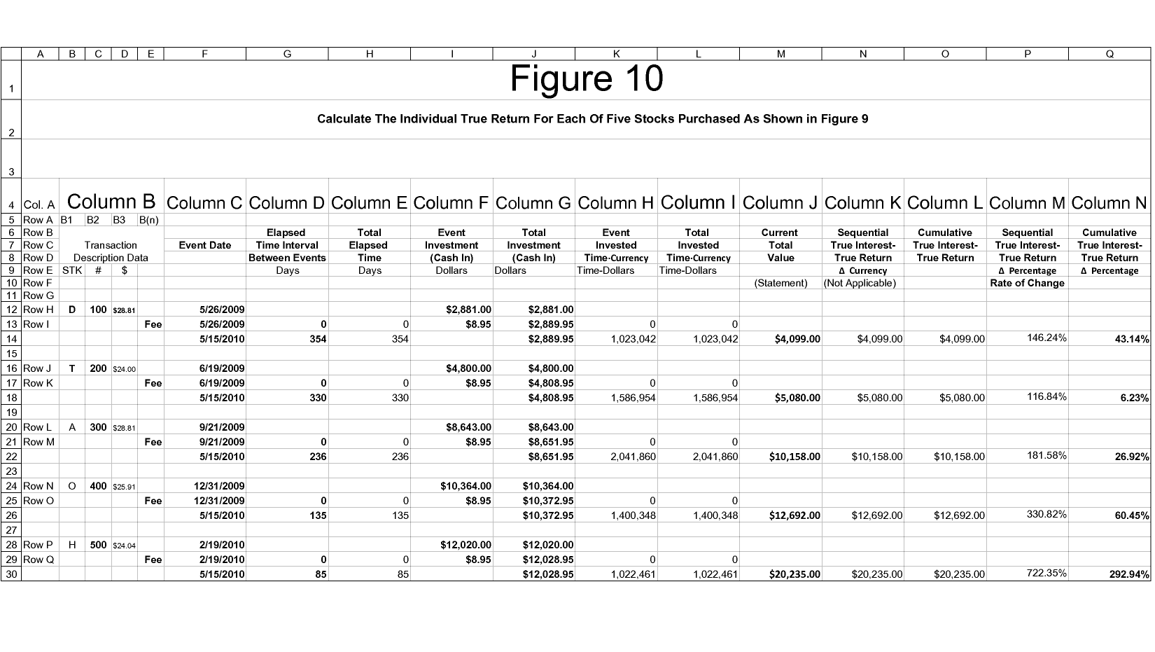

By utilizing spreadsheet technology the relationship of the elements of the invention can easily be summarized on an actual spreadsheet which, in the case of Microsoft's Excel® technology, includes selecting the option of a) Show Formulas as shown in FIG. 1. FIG. 1 shows the spreadsheet formulas to be used and FIGS. 2 through 10 provide illustrations showing how the formulas work in actual practice.

Every investment has investment and cost elements and every borrowing has interest and cost elements. The invention orders these elements over sequential time intervals. One embodiment utilizes days of the year for the time element and US dollars for the investment or cost element. As each investment or borrowing changes over time, the invention tracks the number of dollars utilized and the number of days the dollars are employed and calculates a new investment/cost number referred to as the time-currency factor. The new time-currency factor becomes a new universal measure by which all investments or borrowings may be compared to all other investments or borrowings. The time-currency factor is not dependent upon periodic payments, APR percentages, the so-called time value of money, quarterly closing prices, or any other terms currently employed to calculate interest costs or returns on investments whether these calculations are made by electronic calculators, manually, published formulas or rate books. The invention permits separate individual accounts to be combined into a single account or vice versa. For example, one could have three separate accounts such a broker's account, an individual retirement account (IRA) and a Roth account, and the results of these three accounts could be combined into a single account and ordered as in the invention to show over-all investment returns on a daily basis.

It should be understood, of course, that the foregoing relates to exemplary embodiments of the invention and that modifications may be made without departing from the spirit and scope of the invention as set forth in the following claims.

What is claimed is:

1-2. (canceled)

3. A method comprising:
using a commercially available electronic spreadsheet technology such as Microsoft Excel™ software installed on a compatible commercial computer to calculate true interest costs or true investment returns covering borrowing or investment opportunities by incorporating each cost or return element into a single spreadsheet template thereby enabling the user to compare and select their optimum choice to maximize their financial results;
where true interest costs or true investment returns are defined as annual percentage costs and/or returns that are calculated using a unique “time currency” basis which differs from existing ways of calculating interest costs or investment returns or real interest costs/investment returns and;
where the electronic spreadsheet format has rows and columns;
the spreadsheet is divided into an inactive portion where the rows describe the various financial elements to be studied (Row A indicates that Column B may be sub-divided to allow more detailed data description, Rows B through F indicate the Column Titles and Rows G through L provide the data input) and the columns describe the type of borrowing or investment (Columns B) and an active portion of the spreadsheet including Columns C through N;
Such that in Column C an event date of each financial event is entered in separate consecutive rows in sequential date order;
in Column D an elapsed time Interval between each of the sequential events listed in Column C is calculated using a date function built into the spreadsheet by calculating the number of days between the date in the row and the date shown in the previous row;
Column E accumulates a total elapsed time by adding all the days calculated for each row in a sequential manner;
Column F records the currency element for each event date as shown by each row of the time element;
Column G accumulates a total investment or loan by calculating and accumulating the Total Investment sums for each day in a sequential manner;
Column H is a time-currency term and begins on the second row down and is calculated by multiplying a calculated elapsed time interval on the same row times the total investment or loan shown on the preceding row of Column G;
Column I accumulates a total time-currency by adding all the time-currency calculated for each row in a sequential manner row by row;
Column J inputs a current market value of the investment or the total earnings from a loan or investment that is calculated from market data;
Column K represents the calculated dollar amounts of the true interest or true return for each row time interval;
Column L states the accumulated earnings or interest;
Column M states the percentage rate of change of the rate of return on an investment or the percentage rate of change of the interest on borrowings as calculated by dividing the sequential interest or return in Column K (or the sequential differences shown in Column J) by the total time-currency amount shown in Column H for the same date and annualizing by multiplying that result by 365 for comparison purposes; and
Column N is the cumulative true interest or true return and is calculated by dividing the difference between Column J and Column G by the total time-currency units shown in Column I (all for the same date shown on each row) and annualizing by multiplying that result by 365 for comparison purposes;
thereby determining the true interest or the true return.

4. A single protocol method capable:
of using a commercially available electronic spreadsheet technology such as Microsoft Excel™ software installed on a compatible commercial computer to solve problems involving calculating interest costs or returns on investments; and
is capable of handling time intervals which are either regular or irregular between transaction dates; and
provides the ability to consolidate multiple transactions within a single electronic spreadsheet; and
is easy to learn and understand by an average user who possesses basic computer and electronic spreadsheet knowledge; and
is useful to compare multiple financial alternatives and arrive at the best solutions thereby increasing the user's wealth.
